(19) United States
(12) Patent Application Publication
(10) Pub. No.: US 2006/0124231 A1
(43) Pub. Date: Jun. 15, 2006

(54) Method and apparatus for sheet lamination three-dimensional modeling

(75) Inventors: Toru Nonoyama, Yaizu-shi (JP); Moriaki Sakakura, Nagoya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SUGIMURA SEIKO CORPORATION, Yaizu-shi (JP)

(21) Appl. No.: 11/296,231

(22) Filed: Dec. 8, 2005

(30) Foreign Application Priority Data
Dec. 13, 2004 (JP) 2004-359651

(51) Int. Cl. B29C 65/00; B32B 37/00; B32B 38/04

(52) U.S. Cl. 156/250; 156/510

(57) ABSTRACT

In a sheet lamination three-dimensional modeling method and apparatus, a three-dimensional object is formed in a stacked body by the repetitive operations of stacking and gluing a material sheet on an intermediate stacked body and cutting the material sheet in a cutting plane along the contour of each section shape at the cutting plane of the three-dimensional object. A remainder portion of each material sheet which portion does not constitute any section shape of the three-dimensional object is cut along plural intersecting division lines whose positions are shifted in turn in dependence on the position of each material sheet in a direction of stacking the material sheet so that an unnecessary portion of the stacked body except the three-dimensional object can be divided into plural pieces also in the direction of stacking the material sheet thereby to become small solid blocks and can be removed easily and speedily from the formed three-dimensional object.

### INCORPORATION BY REFERENCE

This application is based on and claims priority under 35 U.S.C. 119 with respect to Japanese Application No. 2004-359651 filed on Dec. 13, 2004, the entire content of which is incorporated herein by reference.

### BACKGROUND OF THE INVENTION

1. Field of the Invention

The present invention relates to a method and apparatus for modeling a three-dimensional object by successively stacking and gluing a plurality of sheets and by cutting each stacked sheet along the contour of each section shape of the three-dimensional object.

2. Discussion of the Related Art

In a sheet lamination three-dimensional modeling apparatus described in Japanese Patent No. 3582339 for example, material sheet supply means 20 stacks a material sheet P on an intermediate stacked body W, heating and pressing means 30 presses and glues the material sheet P on the intermediate stacked body W, and cutting means 40 movable in two dimensional directions within a cutting plane cuts the material sheet P along the contour of each section shape at the cutting plane of a three-dimensional object to be formed, whereby the three-dimensional object is formed in the stacked body by the repetitive operations of these means.

Further, in order to make it easy to remove the unnecessary portion of the stacked body from the three-dimensional object formed in the stacked body, the cutting means 40 cuts the remainder portion of the material sheet P which portion does not constitute any section shape of the three-dimensional object, along grid-like division lines M4 thereby to divide the remainder portion of the stacked body except the three-dimensional object into plural blocks.

As mentioned above, in the prior art sheet lamination three-dimensional modeling apparatus, the cutting means 40 cuts the remainder portion of the material sheet P which portion does not constitute any section shape of the three-dimensional object, along the grid-like division lines M4 in order that the unnecessary portion of the stacked body can be divided into plural blocks. In this case, each of the divided blocks becomes a pillar shape, and hence, the work for removing the blocks, whose lower ends are adhered at a plane to the three-dimensional object, without damaging the same has to be advanced carefully while taking a long period of time. Further, since at an unnecessary portion surrounded by a wall portion of the three-dimensional object, unnecessary blocks thereat cannot be removed unless other blocks therearound are first removed, laborious works and much time are required to remove the unnecessary blocks.

### SUMMARY OF THE INVENTION

Accordingly, it is a primary object of the present invention to provide an improved sheet lamination three-dimensional modeling method and apparatus which enables the unnecessary portion of a stacked body except a formed three-dimensional object, to be removed easily from the formed three-dimensional object.

Briefly, in a first aspect of the present invention, there is provided a sheet lamination three-dimensional modeling method and apparatus, which comprises a step and device for stacking and gluing a material sheet on an intermediate stacked body; a step and device for cutting the material sheet within a cutting plane along the contour of each section shape at the cutting plane of a three-dimensional object to be formed and for cutting a remainder portion of the material sheet which portion does not constitute any section shape of the three-dimensional object, along plural division lines intersecting with one another; and a step and means for causing the steps and devices to be repetitively performed and operated thereby to form the three-dimensional object in the stacked body and to divide an unnecessary portion of the stacked body except the three-dimensional object into plural blocks. Further, the step and device for cutting the remainder portion includes a step and means for shifting the positions of the plural division lines for dividing each material sheet, in turn in dependence on the position of each material sheet in a direction of stacking the material sheet so that each of the plural blocks is divided into plural pieces also in the direction of stacking the material sheet thereby to become small solid blocks.

With this construction in the first aspect of the present invention, the three-dimensional object is formed in the stacked body by the repetitive operations of stacking and gluing the material sheet on the intermediate stacked body and cutting the material sheet along the contour of each section shape at the cutting plane of the three-dimensional object. The remainder portion of each material sheet which portion does not constitute any section shape of the three-dimensional object is cut along the plural intersecting division lines whose positions are shifted in turn in dependence on the position of each material sheet in the direction of stacking the material sheet so that the unnecessary portion of the stacked body except the three-dimensional object can be divided into plural pieces also in the direction of stacking the material sheet thereby to become small solid blocks. Thus, it becomes possible to easily remove the unnecessary portion of the stacked body since the unnecessary portion is divided into plural small solid blocks. Thereafter, by carefully removing the unnecessary portion which is left to border on the three-dimensional object after the removal of the plural blocks, it can be realized to remove the unnecessary portion from the formed three-dimensional object efficiently in a short period of time without damaging the formed three-dimensional object.

In another aspect of the present invention, there is provided a sheet lamination three-dimensional modeling apparatus, which comprises a stacking device for stacking and gluing a material sheet on an intermediate stacked body; a cutting device movable in two-dimensional directions within a cutting plane for cutting the stacked material sheet; means for forming the three-dimensional object in the stacked body by repetitively operating the stacking device to stack and glue the material sheet on the intermediate stacked body and the cutting device to cut the material sheet in the cutting plane along the contour of each section shape at the cutting plane of the three-dimensional object; and division means for operating the cutting device to cut a remainder portion of the material sheet which portion does not constitute any section shape of the three-dimensional object, along plural division lines intersecting with one another to divide an unnecessary portion of the stacked body except the three-dimensional object into plural blocks. The division means includes means for making the cutting device cut each material sheet along the outermost circumferential contour of an image which is made by projecting the three-dimension object onto the cutting plane.

With this construction in the second aspect of the present invention, the three-dimensional object is formed in the stacked body by repetitively operating the stacking device to stack and glue the material sheet on the intermediate stacked body and the cutting device to cut the material sheet in the cutting plane along the contour of each section shape at the cutting plane of the three-dimensional object. Further, each material sheet is cut along the outermost circumferential contour of the image which is made by projecting the three-dimensional object onto the cutting plane. Thus, it can be realized to provide the sheet lamination three-dimensional modeling apparatus which enables the unnecessary portion of the stacked body, which portion is not connected to the three-dimensional object and which portion is outside the outermost circumferential contour of the three-dimensional object, to be removed easily and speedily without damaging the three-dimensional object.

### BRIEF DESCRIPTION OF THE ACCOMPANYING DRAWINGS

The foregoing and other objects and many of the attendant advantages of the present invention may readily be appreciated as the same becomes better understood by reference to the preferred embodiment of the present invention when considered in connection with the accompanying drawings, wherein like reference numerals designate the same or corresponding parts throughout several views, and in which:

FIG. 1 is a schematic perspective view of a sheet lamination three-dimensional modeling apparatus in one embodiment according to the present invention;

FIG. 2 is a side view showing the general construction of the sheet lamination three-dimensional modeling apparatus;

FIG. 3 is a plan view showing the general construction of the sheet lamination three-dimensional modeling apparatus;

FIG. 4 is a flow chart showing a control program for the apparatus;

FIG. 5 is a perspective view of a stacked body whose unnecessary portion has been cut along oblique planes of four kinds;

FIG. 6 is a perspective view showing a small solid block of octahedron;

FIG. 7 is a perspective view showing a small solid block of tetrahedron;

FIG. 8 is a plan view showing the state of each roll paper P having been cut;

FIG. 9 is a flow chart showing a program for calculating the outermost circumferential contour H of a three-dimensional object to be formed;

FIG. 10 is a perspective view showing a sample of STL (Stereolithography) data;

FIG. 11 is a representation showing the state that a boundary line segment between adjoining facets with different signs in the Z-component is projected onto a cutting plane;

FIG. 12 is a plan view showing all of outermost circumferential candidate line segments;

FIG. 13 is an explanatory view for showing the state that an outermost circumferential line segment is chosen from candidate line segments based on a present orientation vector;

FIG. 14 is an explanatory view for showing the state that the end point of an outermost circumferential contour line segment is altered to an intersection and that the start point of an intersecting candidate line segment is altered to the intersection;

FIG. 15 is a plan view showing an outermost circumferential contour made by connecting the outermost circumferential contour line segments; and

FIG. 16 is a perspective view of a stacked body whose unnecessary portion has been cut along oblique planes of two kinds.

### DETAILED DESCRIPTION OF THE PREFERRED EMBODIMENT

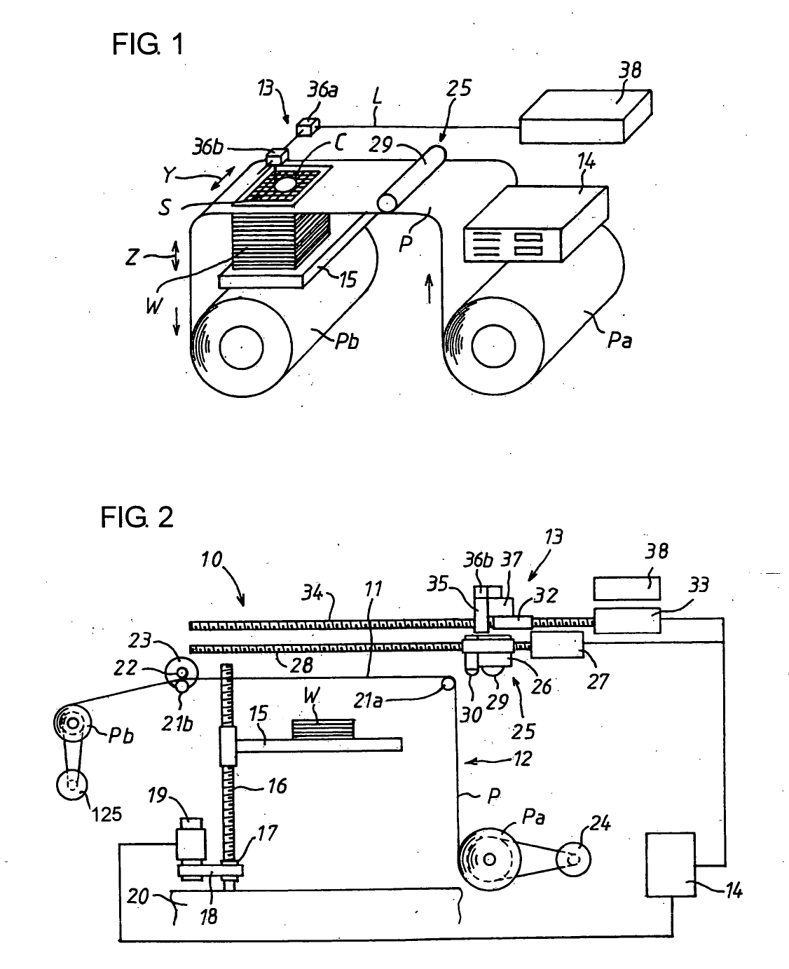

Hereafter, a sheet lamination three-dimensional modeling method and apparatus in one embodiment according to the present invention will be described with reference to the accompanying drawings. Referring now to FIGS. 1 to 3, there is shown a sheet lamination three-dimensional modeling apparatus 10, which is composed of a stacking device 12 for stacking and gluing a material sheet P on an intermediate stacked body W, a cutting device 13 movable in two-dimensional directions within an X-Y plane parallel to a cutting plane 11 for cutting the stacked material sheet P in the cutting plane 11, and a control device 14 for controlling the stacking device 12 and the cutting device 13. The material sheet P is stacked and glued by the stacking device 12 on the intermediate stacked body W and is cut by the cutting device 13 within a cutting plane along the contour of each section shape at the cutting plane 11 of a three-dimensional object to be formed, and a stacked body having the three-dimensional object formed therein is completed by the repetition of such stacking, gluing and cutting operations.

The material sheet P constituting each layer of the intermediate stacked body W and hence, the stacked body is a roll paper of a good quality, whose reverse surface has applied thereto a heat-melting adhesive such as Ethylene-Vinylacetate copolymer. This adhesive is melted by being heated to generate a gluing or adhesive force, but does not have the adhesive force at a room temperature. The material sheet P is not limited to paper and may be synthetic resin sheet such as polyethylene terephthalate or the like.

An elevator table 15 constituting the stacking device 12 is screw-engaged with a pair of elevator feed screws 16 (one only shown) which are supported by a frame 20 to be rotatable about respective vertical axes. When the elevator feed screws 16 are rotated by a servomotor 19 through respective pulleys 17 (one only shown) and a belt 18, the elevator table 15 is moved up and down in the Z-direction while supporting the intermediate stacked body W in the course of the stacking operation. The frame 20 carries a pair of guide rollers 21a and 21b respectively on upstream and downstream sides of the elevator feed screws 16 and at a vertical position adjacent to the upper end of the elevator feed screws 16. The guide rollers 21a and 21b are rotatable respectively about their axes which extend in a Y-direction perpendicular to the X-direction. The frame 20 further carries a feed roller 22 which is kept in contact with the guide roller 21b arranged on the downstream side, and the feed roller 22 is driven by a motor 23 as it is controlled in rotational amount. A paper roll Pa which is made by cylindrically winding a roll paper P of a predetermined width is rotatably carried by the frame 20 on the upstream side of the elevator feed screws 16, and a rotational torque toward the winding direction is applied by a motor 24 to the paper roll Pa. The roll paper P pulled out upward from the paper roll Pa is turned by the guide roller 21a toward the horizontal left-right direction (X-direction), is caused to pass through between the pair of elevator feed screws 16 and is pulled out by being caught by the guide roller 21b and the feed roller 22. The roll paper P so pulled out is taken up by a collecting roll Pb to which a take-up rotational torque is being applied by a motor 125.

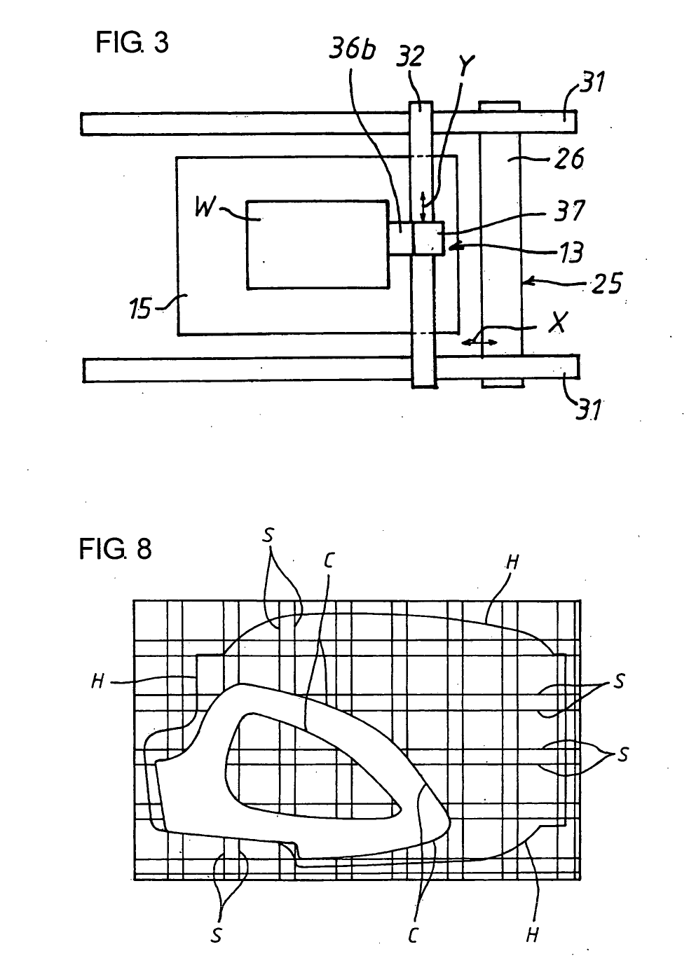

Next, description will be made regarding a heating and pressing device 25 constituting the stacking device 12. As shown in FIG. 3, a pair of first guide rails 31 which extend in the X-direction to be spaced from each other in the horizontal Y-direction perpendicular to the X-direction is mounted on the frame 20 at a position slightly upper than the upper ends of the elevator feed screws 16. A movable head 26 of the heating and pressing device 25 is guided at its both side on lower surfaces of the pair of first guide rails 31. The movable head 26 is moved to reciprocate in the X-direction by a feed screw 28 which is drivingly rotated by a servomotor 27. A cylindrical hot roller 29 whose width is slightly wider than that of the roll paper P is carried by the movable head 26 to be rotatable about its axis as well as to be movable slightly in the vertical direction. The hot roller 29 is heated by a heater (not shown) to a predetermined temperature (in a range of 280 to 300 degrees of centigrade). With the movement of the movable head 26, the heated hot roller 29 is caused to be rolled on the roll paper P placed on the top of the intermediate stacked body W in the course of the stacking operation and heats the roll paper P to melt the adhesive, whereby the roll paper P is pressed by the gravity of the hot roller 29 itself on the top of the intermediate stacked body W to be glued thereon. A detection switch 30 is provided at a front portion of the movable head 26 and at a center portion in the Y-direction. The detection switch 30 delivers a detection signal when the upper surface of the roll paper P is positioned at the cutting plane 11 with the roll paper P being in contact with the intermediate stacked body W which is moved upward together with the elevator table 15. The control device 14 stops the upward movement of the elevator table 15 in response to the detection signal.

The cutting device 13 is provided with a second guide rail 32 which is guided at its opposite ends on the upper surfaces of the pair of first guide rails 31 to extend in the Y-direction. The second guide rail 32 is movable by a feed screw 34, which is drivingly rotatable by a servomotor 33, to reciprocate in the X-direction. A movable head 37 provided with a laser torch 35 and a mirror box 36b is guided on the second guide rail 32 to reciprocate in the Y-direction. Thus, the laser torch 35 is movable together with the movable head 37 in the X and Y-directions relative to the elevator table 15 supporting the intermediate stacked body W, and the moving locus of the laser torch 35 is controlled under CNC control executed by the control device 14. The frame 20 has a laser oscillator 38 secured thereto, and a laser beam L from the laser oscillator 38 is reflected in turn by mirrors which are built in a mirror box 36a secured at one end of the second guide rail 32 and the mirror box 36b attached to the movable head 37 and is radiated downward from the laser torch 35, whereby the roll paper P glued on the top surface of the intermediate stacked body W can be cut within the cutting plane 11. The laser torch 35 is provided with lenses, by which the laser beam L is narrowed at the height of the cutting plane 11 to cut the roll paper P by the narrowed laser beam L. In the cutting device 13, the output power and the cutting speed of the laser beam L are adjusted so that the roll paper P is cut to a depth which is slightly deeper than the thickness of a piece of the roll paper P. The cutting device 13 is not limited to one using the laser beam L as mentioned above and may be one which uses other cutting means such as supersonic wave cutter for example.

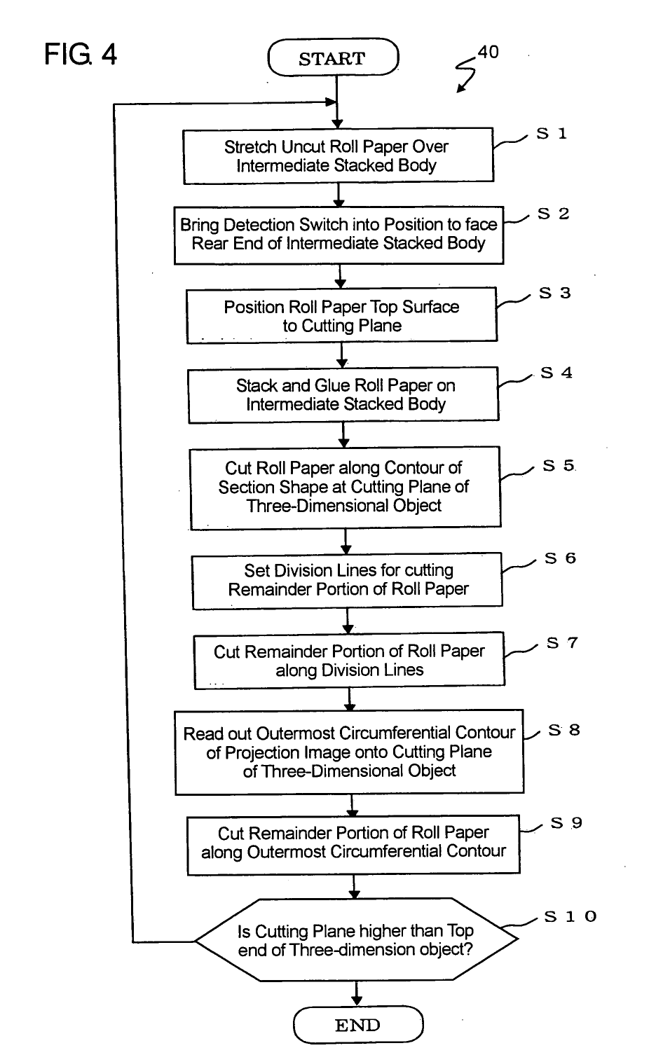

The control device 14 has stored therein a control program 40 (FIG. 4) for controlling the operations of the stacking device 12, the cutting device 13 and the like. Generally speaking, the control program 40 is composed of a forming processing and a division processing. The forming processing is designed for forming a three-dimensional object in a stacked body by repetitively operating the stacking device 12 to stack and glue the roll paper P on the intermediate stacked body W and the cutting device 13 to cut the roll paper P along the contour C of each section shape at the cutting plane 11 of the three-dimensional object. The division processing is designed for operating the cutting device 13 to cut the remainder portion of the roll paper P which portion does not constitute any section shape of the three-dimensional object, along plural division lines S intersecting with one another so that the unnecessary portion of the stacked body except the three-dimensional object can be divided into plural blocks.

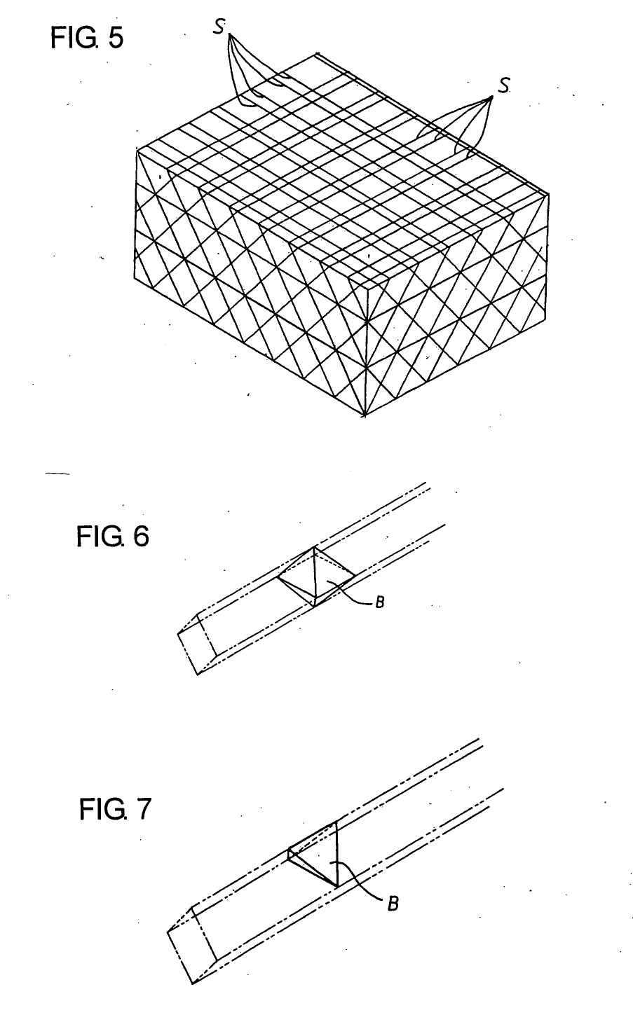

As described later in detail with reference to FIGS. 5 through 8, the division processing includes a step of setting respective division lines S by performing the calculation by which the positions of the plural division lines S for cutting the remainder portion of each stacked roll paper P are shifted in turn in dependence on the position of each roll paper P in the stacking direction so that the unnecessary portion of the stacked body can be divided into plural pieces also in the stacking direction (Z-direction) of the roll paper P thereby to become small solid blocks. The control program 40 also includes a processing for calculating the outermost circumferential contour H of a projection image onto the cutting plane 11 of the three-dimensional object to be formed, and a processing for operating the cutting device 13 to cut the stacked roll paper P along the outermost circumferential contour H.

Next, the operation of the embodiment as constructed above will be described with reference to the control program 40 shown in FIG. 4. The uncut roll paper P which is fed in the X-direction while being caught between the guide roller 21b and the feed roller 22 is stretched between the guide rollers 21a and 21b over the intermediate stacked body W mounted on the elevator table 15 (step S1). The feed screw 28 is rotated by the servomotor 27 to advance the movable head 26, and the detection switch 30 is caused to face the rear end portion of the intermediate stacked body W mounted on the elevator table 15 (step S2). The elevator feed screws 16 are rotated by the servomotor 19 to move the elevator table 15 upward. Thus, when the intermediate stacked body W is brought into contact with the roll paper P to lift the same until the upper surface of the roll paper P is positioned to the cutting plane 11, the detection switch 30 delivers the detection signal to the control device 14, and the control device 14 discontinues the upward movement of the elevator table 15 in response to the detection signal (step S3).

Then, the movable head 26 is advanced to an advanced end in the X-direction, and during the subsequent retraction to a retracted position, the hot roller 29 having been heated to the predetermined temperature is rolled on the roll paper P on the top of the intermediate stacked body W with the movement of the movable head 26. Thus, the roll paper P is heated to melt the adhesive applied on the reverse surface thereof and is pressed and glued on the top surface of the intermediate stacked body W by the gravity of the hot roller 29 itself (step S4).

Thereafter, in order that the laser beam L radiated from the laser torch 35 of the cutting device 13 cuts the roll paper P, stacked and glued on the top surface of the intermediate stacked object W, along the contour C of the section shape at the cutting plane 11 of the three-dimensional object, the movable head 37 is moved by a command from the control device 14 in the X and Y-directions to trace the contour C. During this movement, the laser beam L from the laser oscillator 38 is reflected in turn by the mirror boxes 36a, 36b and is led to the laser torch 35 to be radiated downward therefrom toward the roll paper P (step S5).

Further, in order that the unnecessary portion of the stacked body except the three-dimensional object can be divided into plural blocks, the step S5 is followed by steps S6 and S7, which are provided for operating the cutting device 13 to cut the remainder portion of the roller paper P which portion does not constitute any section shape of the three-dimensional object, along the plural division lines S intersecting with one another. At the step S6, respective division lines S are set by performing the calculation by which the positions of the plural division lines S for cutting the remainder portion of each stacked roll paper P are shifted in turn in dependence on the position of each roll paper P in the stacking direction so that the unnecessary portion of the stacked body can be divided into plural pieces also in the stacking direction (Z-direction) of the roll paper P thereby to become small solid blocks. The movable head 37 is moved in the X and Y-directions, whereby the laser beam L radiated from the leaser torch 35 of the cutting device 13 cuts the remainder portion of the roll paper P along the respective division lines S within the cutting plane 11 (step S7).

As one example at step S6, intersecting lines shown in FIG. 5 can be calculated as the division lines S which intersect with one another on each roll paper P. For the purpose of calculation, there are supposed four kinds of oblique planes for example which extend in parallel through plural pieces of the roll papers P and which are inclined at plus and minus 45 degrees relative to the X-Z plane and the Y-Z plane. Then, the intersecting lines S are defined as those which the four kinds of oblique planes make with each roll paper P and which appear on the remainder portion of each roll paper P when the remainder portion of the stacked body is cut by the four kinds of oblique planes at plural positions spaced by a predetermined distance (d) in each of the oblique directions. When the remainder portion is then cut by these four oblique planes at the predetermined interval, the remainder portion of the stacked body can be divided into small solid blocks of octahedron and tetrahedron, as shown respectively in FIGS. 6 and 7. The dimension of the small solid blocks can be arbitrarily changed by inputting the predetermined distance (d) by an input device into the control device 14.

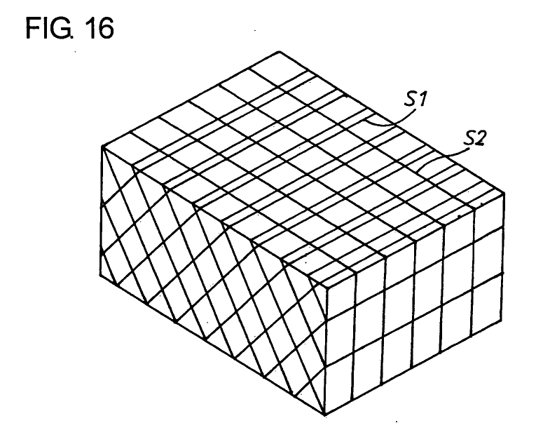

Alternatively, as shown in FIG. 16, the position of each of the division lines S1 extending in the Y-direction for cutting the remainder portion of the roll paper P may be set to be shifted in dependence on its position in the stacking direction, while the position of each of the division lines S2 extending in the X-direction may be set not to be shifted regardless of its position in the stacking direction. Conversely, the position of each division line extending in the Y-direction is kept fixed, while the position of each division line extending in the X-direction may be shifted in turn in dependence on its position in the stacking direction. In either of these modified cases, the unnecessary portion can be divided into plural pieces also in the stacking direction and hence, becomes easier to remove.

Further alternatively, the unnecessary portion of the stacked body may be divided into plural pillar-shape blocks whose cross-section is polygon or circle, and then, the pillar-shape blocks may be cut by the planes which are inclined relative to the X-Y plane at plural positions each spaced by the predetermined distance (d) from one another. In this modified case, the intersecting lines which the plural planes inclined relative to the X-Y plane make with each of the stacked roll papers P and which appear at the remainder portion of each roll paper P and the contour of a polygon or circle which defines the cross-section of each pillar-shape block can be calculated as the division lines S which intersect with one another on each roll paper P.

The outermost circumferential contour H of a projection image onto the cutting plane 11 of the three-dimensional object (i.e., the image which is made by projecting the three-dimensional object onto the cutting plane 11) is used to cut the roll paper P therealong. The outermost circumferential contour H is made when STL (Stereolithography) data defining the three-dimensional shape of the three-dimensional object is read into the control device 14 and is stored in a memory device such as hard disc or the like of the control device 14. At the time of cutting, the outermost circumferential contour H is read out from the memory device (step S8), and then, step S9 is then executed to cut the roll paper P along the outermost circumferential contour H. By the repetitive executions of the aforementioned steps S1 through S9, each of the stacked roll papers P is cut along the contour C of each section shape of the three-dimensional object, the division lines S and the outermost circumferential contour H, as shown in FIG. 8.

When the position of the cutting plane 11 in the Z-axis direction with respect to the three-dimensional object becomes higher than the top end of the three-dimension object, it is judged at step S10 that the three-dimensional object no longer has any section shape to be formed in the cutting plane 11. Steps 1 through 9 are repeated until such judgment is made at step S10. When such judgment is made at step S10, the forming of the three-dimensional object in the stacked body has been completed, the unnecessary portion of the stacked-body has been divided into plural small solid blocks B, and the stacked body has been cut along the outermost circumferential contour H of the projection image onto the cutting plane 11 of the three-dimensional object.

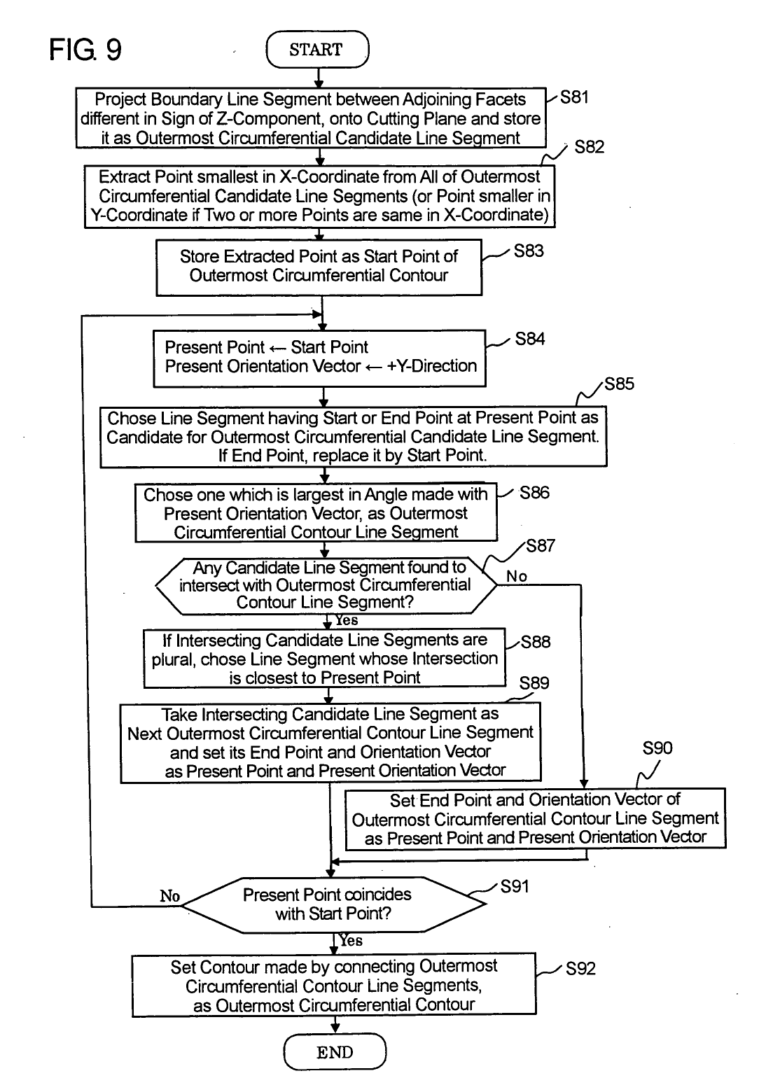

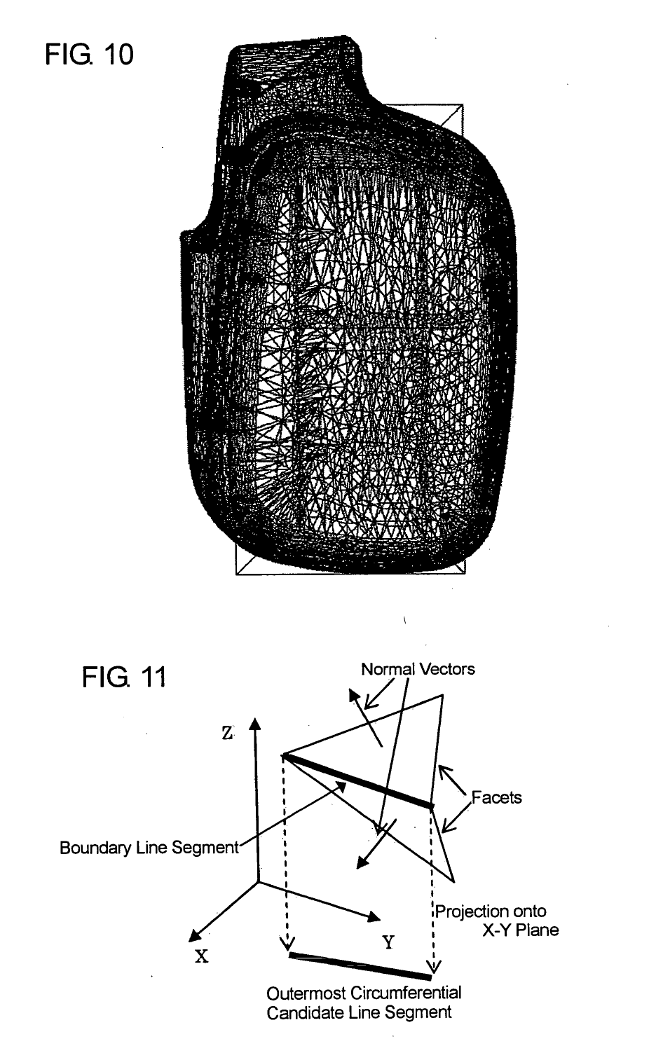

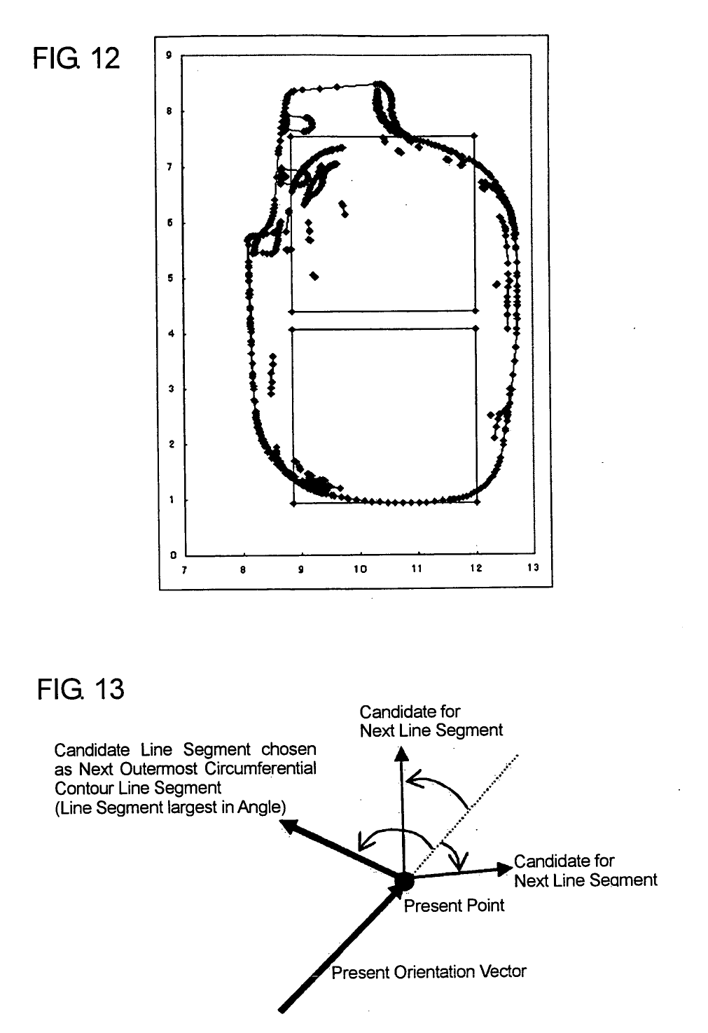

FIG. 9 shows an example of the processing which the control device 14 executes for defining the outermost circumferential contour H. With respect to facets each of which is a triangle plane constituting the STL data (whose sample is shown in FIG. 10) defining the three-dimensional shape of the three-dimensional object, comparison is made of respective normal vectors of adjoining facets, and if the vectors differ in the signs of their Z-components, a line segment constituting the boundary is projected onto the cutting plane (X-Y plane) as shown in FIG. 11 and is stored as an outermost circumferential candidate line segment (step S81). Of respective start points and end points of all the outermost circumferential candidate line segments, a point which is the smallest in the X-coordinate (smaller one in Y-coordinate if two or more points have the same smallest values in X-coordinate) is extracted (step S82) and is stored as a start point of the outermost circumferential contour H (step S83). The start point is set as a present point in a present point memory, and +Y-direction is set as the present orientation vector in a present orientation vector memory (step S84). A candidate line segment which has the present point as its start or end point is chosen as a candidate for the next outermost circumferential contour line segment. If the present point is the end point of the candidate line segment, it is replaced by the start point (step S85). As shown in FIG. 13, with the present orientation vector taken as reference and with the counterclockwise direction taken as positive-going, calculation is made for an angle which the orientation vector (the vector heading for the end point from the start point) of each line segment makes with the present orientation vector, and a line segment having the largest angle is chosen as the next outermost circumferential contour line segment (step S86).

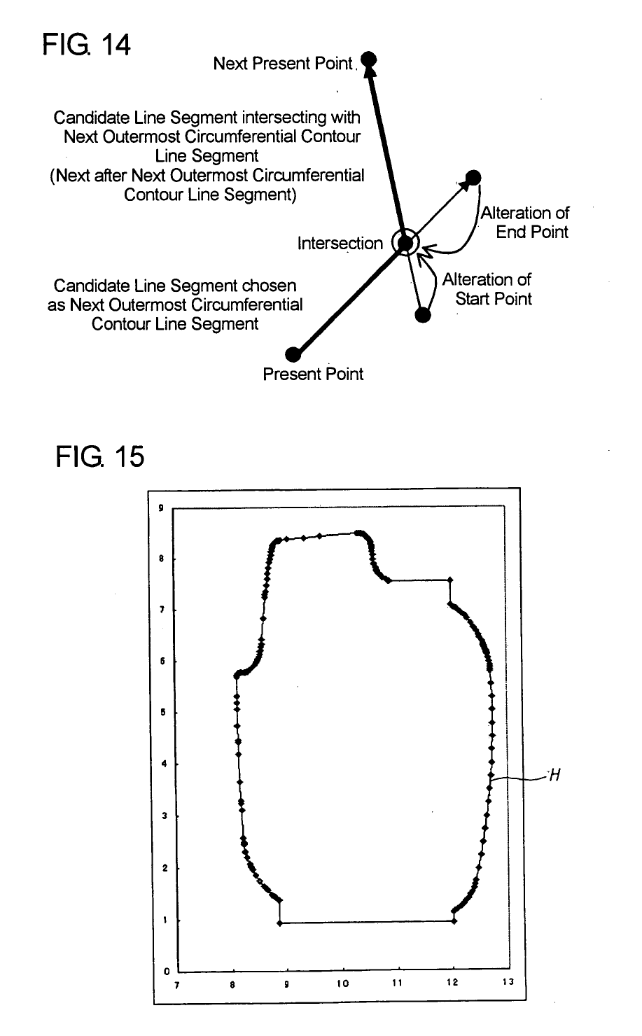

Judgment is made (step S87) of whether or not there is found any candidate line segment intersecting with the next outermost circumferential contour line segment obtained at step S86. If there are plural intersecting candidate line segments, a line segment whose intersection is closest to the present point is chosen as the next after next outermost circumferential contour line segment (step S88). As shown in FIG. 14, the end point of the next outermost circumferential contour line segment is altered to the intersection, and the start point of the intersecting candidate line segment, that is, of the next after next outermost circumferential contour line segment is altered to the intersection. The intersecting candidate line segment is taken as the next after next outermost circumferential contour line segment, whose end point is set as the present point in the present point memory and whose orientation vector is set as the present orientation vector in the present orientation vector memory (step S89). If any intersecting candidate line segment is not found at step S87, the end point of the next outermost circumferential contour line segment obtained at step S86 is set as the present point in the present point memory, and the orientation vector of that next one obtained at step S86 is set as the present orientation vector in the present orientation vector memory (step S90). To follow the step S89 or S90, judgment is made (step S91) of whether or not the content of the present point memory is in coincidence with the start point. If no coincidence is made, the steps S84 through S91 are repetitively executed until such coincidence is made. When the coincidence is made, a contour which is made by successively connecting the candidate line segments which have been chosen as the outermost circumferential contour line segments is set as the outermost circumferential contour line H (refer to FIG. 15) of the projection image onto the cutting plane 11 of the three-dimensional object (step S92), after which the processing for the outermost circumferential contour H is terminated.

In the foregoing embodiment, the unnecessary- portion of the stacked body is divided into plural small solid blocks B, and cutting is performed along the outermost circumferential contour H of the projection image onto the cutting plane 11 of the three-dimensional object. In an alternative form, however, there may be done either one only of the division of the unnecessary portion and the cutting along the outermost circumferential contour H. Further, in another modified form, the unnecessary portion only between the outermost circumferential contour H and the three-dimensional object may be divided into plural small solid blocks B, and the unnecessary portion outside the outermost circumferential contour H may be divided along grid-like division lines into piliar-shape blocks.

Various features and many of the attendant advantages in the foregoing embodiment will be summarized as follows:

In the sheet lamination three-dimensional modeling method in the foregoing embodiment typically shown in FIGS. 1, 2 and 4 to 7, the three-dimensional object is formed in the stacked body by the repetitive operations of stacking and gluing the material sheet P on the intermediate stacked body W and cutting the material sheet P in the cutting plane 11 along the contour C of each section shape at the cutting plane 11 of the three-dimensional object. The remainder portion of each material sheet P which portion does not constitute any section shape of the three-dimensional object is cut along the plural intersecting division lines S whose positions are shifted in turn in dependence on the position of each material sheet P in the direction of stacking the material sheet P so that the unnecessary portion of the stacked body except the three-dimensional object can be divided into plural pieces also in the direction of stacking the material sheet P thereby to become small solid blocks B. Thus, it becomes possible to easily remove the unnecessary portion of the stacked body since the unnecessary portion is divided into plural small solid blocks B. Thereafter, by carefully removing the unnecessary portion which is left to border on the three-dimensional object after the removal of the plural blocks B, it can be realized to remove the unnecessary portion from the formed three-dimensional object efficiently in a short period of time without damaging the formed three-dimensional object.

Also in the sheet lamination three-dimensional modeling method in the foregoing embodiment typically shown in FIGS. 5 to 7, the unnecessary portion of the stacked body except the three-dimensional object is divided into the small solid blocks B of octahedron and tetrahedron. The positions of the plural intersecting division lines S for cutting the remainder portion of each material sheet P which portion does not constitute any section shape of the three-dimensional object can be easily calculated and set to be shifted in turn in dependence on the position of each material sheet P in the direction of the stacking the material sheet P.

Also in the sheet lamination three-dimensional modeling method in the foregoing embodiment typically shown in FIGS. 4 and 8, it can be realized to easily remove the unnecessary portion of the stacked body which portion has been divided into the plural small solid blocks B, and it can also be realized to easily and speedily remove the unnecessary portion of the stacked body which portion is outside the outermost circumferential contour H of the three-dimensional object, without damaging the three-dimensional object.

Also in the sheet lamination three-dimensional modeling method in the foregoing embodiment typically shown in FIGS. 4 and 8, the three-dimensional object is formed in the stacked body by the repetitive operations of stacking and gluing the material sheet P on the intermediate stacked body W. and cutting the material sheet P in the cutting plane 11 along the contour C of each section shape at the cutting plane 11 of the three-dimensional object. Each material sheet P is also cut along the outermost circumferential contour H of the image which is made by projecting the three-dimension object onto the cutting plane 11. Thus, it can be realized to easily and speedily remove the unnecessary portion of the stacked body which portion is outside the outermost circumferential contour H of the three-dimensional object to be out of the connection therewith, without damaging the three-dimensional object.

Further, in the sheet lamination three-dimensional modeling apparatus 10 in the foregoing embodiment typically shown in FIGS. 1, 2 and 4 to 7, the three-dimensional object is formed in the stacked body by repetitively operating the stacking device 12 to stack and glue the material sheet P on the intermediate stacked body W and the cutting device 13 to cut the material sheet P in the cutting plane 11 along the contour C of each section shape at the cutting plane 11 of the three-dimensional object. The cutting device 13 also cuts the remainder portion of each material sheet P which portion does not constitute any section shape of the three-dimensional object, along the plural intersecting division lines S whose positions are shifted in turn in dependence on the position of each material sheet P in the direction of stacking the material sheet P so that the unnecessary portion of the stacked body except the three-dimensional object can be divided into plural pieces also in the direction of stacking the material sheet P thereby to become small solid blocks B. Thus, it can be realized to provide the sheet lamination three-dimensional modeling apparatus 10 which makes it possible first to easily remove the unnecessary portion of the stacked body which portion has been divided into plural small solid blocks B and then to carefully remove the unnecessary portion which is left to border on the formed three-dimensional object after the removal of the plural blocks B, so that the removal of the unnecessary portion from the three-dimensional object can be done in a short period of time without damaging the formed three-dimensional object.

Further, in the sheet lamination three-dimensional modeling apparatus 10 in the foregoing embodiment typically shown in FIGS. 1, 2, 4 and 8, the three-dimensional object is formed in the stacked body by repetitively operating the stacking device 12 to stack and glue the material sheet P on the intermediate stacked body W and the cutting device 13 to cut the material sheet P in the cutting plane 11 along the contour C of each section shape at the cutting plane 11 of the three-dimensional object. The cutting device 13 also cuts each material sheet P along the outermost circumferential contour H of the image which is made by projecting the three-dimension object onto the cutting plane 11. Thus, it can be realized to provide the sheet lamination three-dimensional modeling apparatus 10 which makes it possible to easily and speedily remove the unnecessary portion of the stacked body which portion is outside the outermost circumferential contour H of the three-dimensional object to be out of connection thereto, without damaging the three-dimensional object.

Obviously, further numerous modifications and variations of the present invention are possible in light of the above teachings. It is therefore to be understood that within the scope of the appended claims, the present invention may be practiced otherwise than as specifically described herein.

What is claimed is:

1. A sheet lamination three-dimensional modeling method comprising the steps of:
stacking and gluing a material sheet on an intermediate stacked body;
cutting the material sheet in a cutting plane along the contour of each section shape at the cutting plane of a three-dimensional object to be formed;
cutting a remainder portion of each material sheet which portion does not constitute any section shape of the three-dimensional object, along plural division lines intersecting with one another; and
repeating the stacking and gluing step and the cutting steps to form a three-dimensional object in a stacked body and to divide an unnecessary portion of the stacked body except the three-dimensional object into plural blocks;
wherein the step of cutting the remainder portion includes a step of shifting the positions of the plural division lines for dividing each material sheet, in turn in dependence on the position of each material sheet in a direction of stacking the material sheet so that each of the plural blocks is divided into plural pieces also in the direction of stacking the material sheet thereby to become small solid blocks.

2. The method as set forth in claim 1, wherein the small solid blocks comprise octahedra and tetrahedra.

3. The method as set forth in claim 1, wherein the step of cutting the remainder portion includes a step of cutting each material sheet along the outermost circumferential contour of an image which is made by projecting the three-dimension object onto the cutting plane.

4. The method as set forth in claim 2, wherein the step of cutting the remainder portion includes a step of cutting each material sheet along the outermost circumferential contour of an image which is made by projecting the three-dimension object onto the cutting plane.

5. A sheet lamination three-dimensional modeling method comprising the steps of:
stacking and gluing a material sheet on an intermediate stacked body;
cutting the material sheet in a cutting plane along the contour of each section shape at the cutting plane of a three-dimensional object to be formed;
cutting a remainder portion of each material sheet which portion does not constitute any section shape of the three-dimensional object, along plural division lines intersecting with one another; and
repeating the stacking and gluing step and the cutting steps to form the three-dimensional object in a stacked body and to divide an unnecessary portion of the stacked body except the three-dimensional object into plural blocks;
wherein the step of cutting the remainder portion includes a step of cutting the each material sheet along the outermost circumferential contour of an image which is made by projecting the three-dimension object onto the cutting plane.

6. A sheet lamination three-dimensional modeling apparatus comprising:
a stacking device for stacking and gluing a material sheet on an intermediate stacked body;
a cutting device movable in two-dimensional directions within a cutting plane for cutting the stacked material sheet;
means for forming a three-dimensional object in the stacked body by repetitively operating the stacking device to stack and glue the material sheet on the intermediate stacked body and the cutting device to cut the material sheet in the cutting plane along the contour of each section shape at the cutting plane of the three-dimensional object; and
division means for operating the cutting device to cut a remainder portion of the material sheet which portion does not constitute any section shape of the three-dimensional object, along plural division lines intersecting with one another to divide an unnecessary portion of the stacked body except the three-dimensional object into plural blocks;
wherein the division means includes setting means for shifting the positions of the plural division lines for cutting the remainder portion of each material sheet, in turn in dependence on the position of each material sheet in a direction of stacking the material sheet so that each of the plural blocks is divided into plural pieces also in the direction of stacking the material sheet thereby to become small solid blocks.

7. A sheet lamination three-dimensional modeling apparatus comprising:
a stacking device for stacking and gluing a material sheet on an intermediate stacked body;
a cutting device movable in two-dimensional directions within a cutting plane for cutting the stacked material sheet;
means for forming a three-dimensional object in the stacked body by repetitively operating the stacking device to stack and glue the material sheet on the intermediate stacked body and the cutting device to cut the material sheet in the cutting plane along the contour of each section shape at the cutting plane of the three-dimensional object; and
division means for operating the cutting device to cut a remainder portion of the material sheet which portion does not constitute any section shape of the three-dimensional object, along plural division lines intersecting with one another to divide an unnecessary portion of the stacked body except the three-dimensional object into plural blocks;
wherein the division means includes means for making the cutting device cut each material sheet along the outermost circumferential contour of an image which is made by projecting the three-dimension object onto the cutting plane.
